(19) United States
(12) Patent Application Publication
(10) Pub. No.: US 2008/0007775 A1
(43) Pub. Date: Jan. 10, 2008

(54) Image processing apparatus, image processing method, and program

(75) Inventors: Yuki Mizobuchi, Nara (JP); Takao Fukuda, Nara-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/825,292

(22) Filed: Jul. 5, 2007

(30) Foreign Application Priority Data
Jul. 6, 2006 (JP) 2006-186803

(51) Int. Cl. G06F 3/12

(52) U.S. Cl. 358/1.15

(57) ABSTRACT

An image processing apparatus is provided that can not only print using an apparatus with a low power consumption of a plurality of image forming apparatuses but also can cause the user to promote the ecology. The image processing apparatus (an image forming apparatus or a PC) connected to a plurality of external image forming apparatuses through a network includes a startup state detecting portion that detects a startup state of each of the external image forming apparatuses, an apparatus selecting portion that selects, as a candidate apparatus to execute printing of an inputted image, an apparatus that can print with a low power consumption based on the startup state detected by the startup state detecting portion, from the external image forming apparatuses; and an apparatus presenting portion that presents to a user whether the candidate apparatus selected by the apparatus selecting portion is used, being selectable by the user.

### CROSS-NOTING PARAGRAPH

This Non-provisional application claims priority under 35 U.S.C. §119(a) on Patent Application No. 2006-186803 filed in JAPAN on Jul. 6, 2006, the entire contents of which are hereby incorporated herein by reference.

### FIELD OF THE INVENTION

The present invention relates to an image processing apparatus, an image processing method, and program and more specifically to an image processing apparatus that gives instructions to an image forming apparatus such as a printer, a copying machine, and a multifunction peripheral to print, an image processing method, and a program to be installed in the image processing apparatus in the system that one or more those apparatuses and peripherals are connected each other through the network.

### BACKGROUND OF THE INVENTION

Recently, in various devices, low-power-consumption types of devices have been popularized to reduce the power consumption from the viewpoint of attaching importance to the environmental conservation and the environmentally-friendly performance. In the International Energy Star Program, standard values of energy consumptions are defined for seven kinds of items, that is, computers, displays, printers, scanners, facsimile machines, copying machines, and multifunction peripherals (see, for example, an incorporated foundation “The Energy Conservation Center, Japan”, “Standard Values of Energy Saving under the International Energy Star Program”, [online], [retrieved on May 18, 2006], the Internet <URL: http://www.eccj.or.jp/ene-star/prog/p9.html>).

Japanese Laid-Open Patent Publication No. 2005-271512 discloses an image forming apparatus system that can keep the total power consumption thereof equal to or less than a predetermined power consumption without including any personal computer (PC), etc., to manage the total power consumption of a plurality of image forming apparatuses connected to a network.

Though the system disclosed in the above Japanese Laid-Open Patent Publication No. 2005-271512 executes printing with the power consumption thereof equal to or less than a predetermined power consumption from a viewpoint of the ecology, it is processed in that system so that a managing server or a printer driver automatically selects a low-power-consumption apparatus and transfers a job to the selected printer. Therefore, a user has to move to the places where the printers are equipped to check which printer has been used for the printing. No problem arises when the printed sheet is present at the printer at the first place to which the user has moved. However, the user has to move again to the place where another printer is equipped when the printed matter is not present at the printer at the first place. As described above, in the conventional system, no convenience is present for the user and the user can not be caused to promote the ecology.

### SUMMARY OF THE INVENTION

The object of the invention is to provide an image processing apparatus that can not only print using a low-power-consumption apparatus of a plurality image forming apparatuses that are connected to the image processing apparatus through a network but also cause a user to recognize an apparatus that actually executes printing, and that can cause a user to promote the ecology, an image processing method therefor, and a program to be installed in the image processing apparatus.

More specifically, the object of the present invention is to provide an image processing apparatus connected to a plurality of external image forming apparatuses through a network, which comprises: a startup state detecting portion that detects a startup state of each of the external image forming apparatuses; an apparatus selecting portion that selects, as a candidate apparatus to execute printing of an inputted image, an apparatus that is able to print with a low power consumption based on the startup state detected by the startup state detecting portion, from the external image forming apparatuses; and an apparatus presenting portion that presents to a user whether the candidate apparatus selected by the apparatus selecting portion is used, being selectable by the user.

The object of the present invention is to provide the image processing apparatus, wherein the apparatus presenting portion presents to the user presentation informing that electric power is saved by printing using the candidate apparatus selected by the apparatus selecting portion, and whether the candidate apparatus is used, being selectable by the user.

The object of the present invention is to provide the image processing apparatus, wherein the apparatus selecting portion selects an apparatus for which the startup state detected by the startup detecting portion indicates warming up thereof has completed and that is able to print with a low power consumption from the external image forming apparatuses as the candidate apparatus.

The object of the present invention is to provide the image processing apparatus, further comprising a job analyzing portion that analyzes a printing job for the inputted image, wherein the apparatus selecting portion selects an apparatus that is able to execute the printing job analyzed by the job analyzing portion and that is able to print with a low power consumption based on the startup state detected by the startup state detecting portion from the external image forming apparatuses as the candidate apparatus.

The object of the present invention is to provide the image processing apparatus, further comprising a characteristic obtaining portion that obtains and stores characteristic information including a power consumption and the printing performance of each apparatus of the external image forming apparatus, wherein the apparatus selecting portion selects an apparatus that is able to print with a low power consumption referring to the characteristic information of each apparatus stored in the characteristic obtaining portion.

The object of the present invention is to provide the image processing apparatus, further comprising a job analyzing portion that analyzes a printing job for the inputted image, wherein the apparatus selecting portion selects an apparatus that is able to execute the printing job analyzed by the job analyzing portion even permitting a change of the printing mode thereof and that is able to print with a low power consumption based on the startup state detected by the startup state detecting portion from the external image forming apparatuses as the candidate apparatus.

The object of the present invention is to provide the image processing apparatus, wherein when the printing job is a color printing job as the result of the analysis of the printing job by the job analyzing portion, the apparatus selecting portion selects an apparatus that is able to execute the printing job as a printing job for printing in black and white and that is able to print with a low power consumption based on the startup state detected by the startup state detecting portion from the external image forming apparatuses as the candidate apparatus.

The object of the present invention is to provide the image processing apparatus, wherein when the printing job is a printing job that uses a finisher as the result of the analysis of the printing job by the job analyzing portion, the apparatus selecting portion selects an apparatus that is able to execute the printing job as a printing job that does not use any finisher and that is able to print with a low power consumption based on the startup state detected by the startup state detecting portion from the external image forming apparatuses as the candidate apparatus.

The object of the present invention is to provide the image processing apparatus, wherein when the printing job is a printing job to execute single side printing as the result of the analysis of the printing job by the job analyzing portion, the apparatus selecting portion selects an apparatus that is able to execute the printing job as a printing job to execute duplex printing and that is able to print with a low power consumption based on the startup state detected by the startup state detecting portion from the external image forming apparatuses as the candidate apparatus.

The object of the present invention is to provide the image processing apparatus, wherein the apparatus selecting portion selects an apparatus that is able to execute the printing job analyzed by the job analyzing portion as a printing job to execute aggregating printing and that is able to print with a low power consumption based on the startup state detected by the startup state detecting portion from the external image forming apparatuses as the candidate apparatus.

The object of the present invention is to provide the image processing apparatus, wherein the image processing apparatus is a computer.

The object of the present invention is to provide the image processing apparatus, wherein the image processing apparatus is an image forming apparatus, and wherein the processing aimed at the external image forming apparatuses is aimed at not only the external image forming apparatuses but also the image processing apparatus itself.

The object of the present invention is to provide an image processing method of executing a printing instruction in an image processing apparatus connected to a plurality of external image forming apparatuses through a network, which includes: a startup state detecting step at which a startup state detecting portion detects the startup state of each of the external image forming apparatuses; an apparatus selecting step at which an apparatus selecting portion selects an apparatus that is able to print with a low power consumption based on the startup state detected at the startup state detecting step from the external image forming apparatuses as a candidate apparatus to be caused to execute printing of an inputted image; and an apparatus presenting step at which an apparatus presenting portion presents whether the candidate apparatus selected at the apparatus selecting step is used to a user being executable by the user.

The object of the present invention is to provide a program to be installed in a controlling portion of an image processing apparatus connected to a plurality of external image forming apparatuses through a network and to execute a printing instruction, wherein the program causes the controlling portion to execute a startup state detecting step of detecting the startup state of each of the external image forming apparatuses, an apparatus selecting step of selecting an apparatus that can print with a low power consumption based on the startup state detected at the startup state detecting step from the external image forming apparatuses as a candidate apparatus to be caused to execute printing of an inputted image; and an apparatus presenting step of presenting whether the candidate apparatus selected at the apparatus selecting step is used to a user being executable by the user.

### BRIEF DESCRIPTION OF THE DRAWINGS

FIG. 1 depicts an exemplary con figuration of a printing system including an image processing apparatus according to an embodiment of the present invention;

FIG. 2 depicts a block diagram of an exemplary configuration of a multipurpose computer that can be incorporated instead of an image forming apparatus as an image processing apparatus according to the present invention in the system of FIG. 1;

FIG. 3 depicts an example of a printing setting picture in the image forming apparatus of FIG. 1;

FIG. 4 depicts an example of a display of a substitute apparatus proposing image in the printing setting picture of FIG. 3;

FIG. 5 depicts another example of a display of a substitute apparatus proposing image in the printing setting picture of FIG. 3; and

FIG. 6 depicts an explanatory flowchart of an example of a substitute apparatus proposing processing in the image forming apparatus of FIG. 1 and is also an explanatory flowchart of an example of an image processing method according to an embodiment of the present invention.

### PREFERRED EMBODIMENTS OF THE INVENTION

An image processing apparatus according to the present invention is an apparatus to instruct one external image forming apparatus of a plurality of external image forming apparatuses connected through a network, to print. The image processing apparatus according to the present invention and the plurality of external image forming apparatuses constitute a printing system. Any apparatus that can execute printing for image data inputted by reading a document or reading a file (reception of a file or reception of a printing job) onto a recording paper sheet, etc., can be applied to the external image forming apparatus, and a copier, facsimile, a printer including a multifunction peripheral having a copying function, a facsimile function, a printing function, etc., are used for that apparatus.

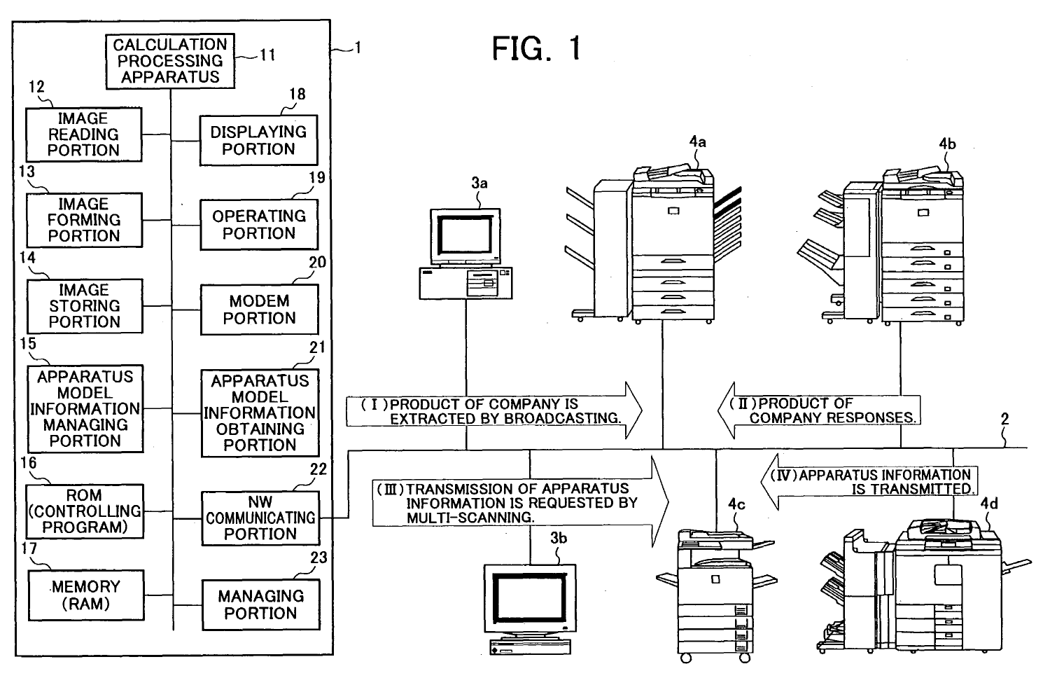

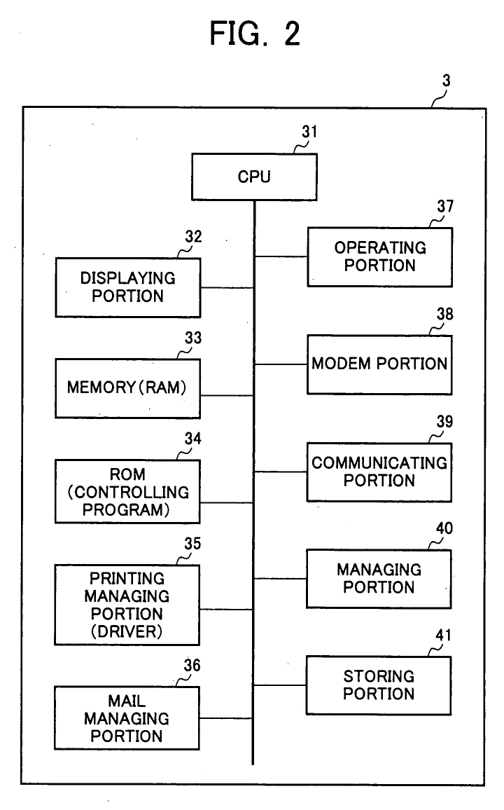

The image processing apparatus according to the present invention may only be able to instruct at least an external image forming apparatus to print, and the image processing apparatus itself may be an image forming apparatus similar to the external image forming apparatus or may be a computer such as a PC. When the image processing apparatus according to the present invention is constituted of an image forming apparatus, for example, as described later referring to FIG. 1, a printing setting GUI (Graphical User Interface) program that can be displayed by an operating portion of the apparatus may be installed in a controlling portion. When the image processing apparatus according to the present invention is constituted of a computer, for example, as described later referring to FIG. 2, a program may be installed by being stored in various ROMs (Read Only Memories) or a hard disk, being executable by a CPU (Central Processing Unit) as a program accompanied by a GUI such as so-called a printer driver or a printer monitoring program.

FIG. 1 depicts an exemplary configuration of a printing system including an image processing apparatus according to an embodiment of the present invention. In FIG. 1: “1” denotes an image forming apparatus as an example of the image processing apparatus; “2” denotes a network such as a LAN (Local Area Network), a WAN (Wide Area Network), or the Internet; “3a” and “3b” denote PCs; “4a” to “4b” denote external image forming apparatuses; “11” denotes a calculating processing apparatus such as a CPU or an MPU (Micro-Processing Unit); “12” denotes an image reading portion; “13” denotes an image forming portion; “14” denotes an image storing portion; “15” denotes an apparatus model information managing portion; “16” denotes a ROM that stores a controlling program, etc; “17” denotes a memory such as a RAM (Random Access Memory); “18” denotes a displaying portion; “19” denotes an operating portion; “20” denotes a modem portion; “21” denotes an apparatus model information obtaining portion; “22” denotes a network (NW) communicating portion; and “23” denotes a managing portion.

FIG. 2 depicts a block diagram of an exemplary configuration of a general-purpose computer that can be incorporated instead of an image forming apparatus as an image processing apparatus according to the present invention in the system of FIG. 1. In FIG. 2: “3” denotes a PC; “31” denotes a CPU; “32” denotes a displaying portion; “33” denotes a memory such as a RAM; “34” denotes a ROM that stores an operating system (OS) and other controlling programs; “35” denotes a printing managing portion (a driver); “36” denotes a mail managing portion; “37” denotes an operating portion; “38” denotes a modem portion; “39” denotes a communicating portion; “40” denotes a managing portion; and “41” denotes a storing portion.

The PC 3 of FIG. 2 can be said to be the PCs 3a and 3b on the network 2 that is same as that of the printing system of FIG. 1. However, referring to FIG. 1, description will be given for an example of the image forming apparatus 1 that functions as the image processing apparatus according to the present invention and, referring to FIG. 2, description will be given for an example of the PC 3 that is provided instead of the image forming apparatus of FIG. 1 and that functions as the image processing apparatus according to the present invention. The connection form of the image processing apparatus according to the present invention and the external image forming apparatus is not limited to the above examples. The image processing apparatus may only include portion described later that are the featured parts of the present invention.

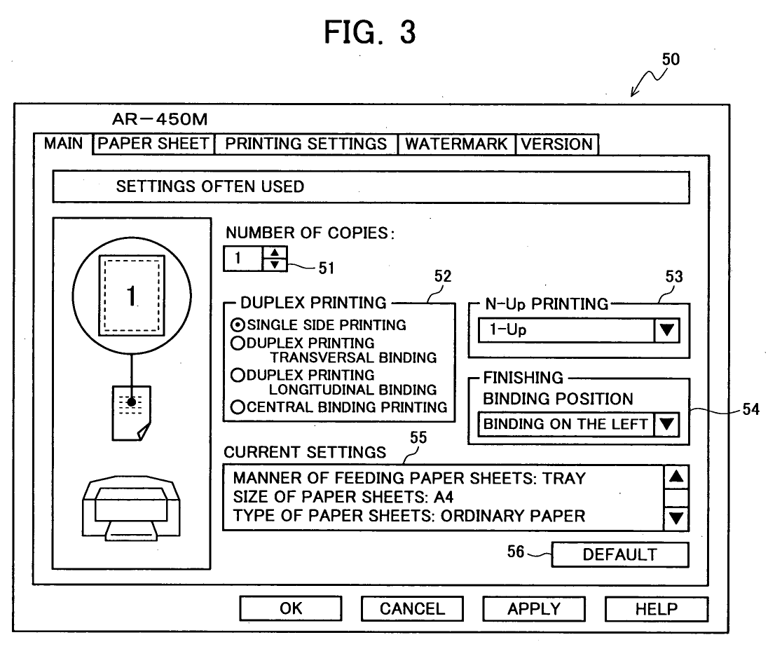

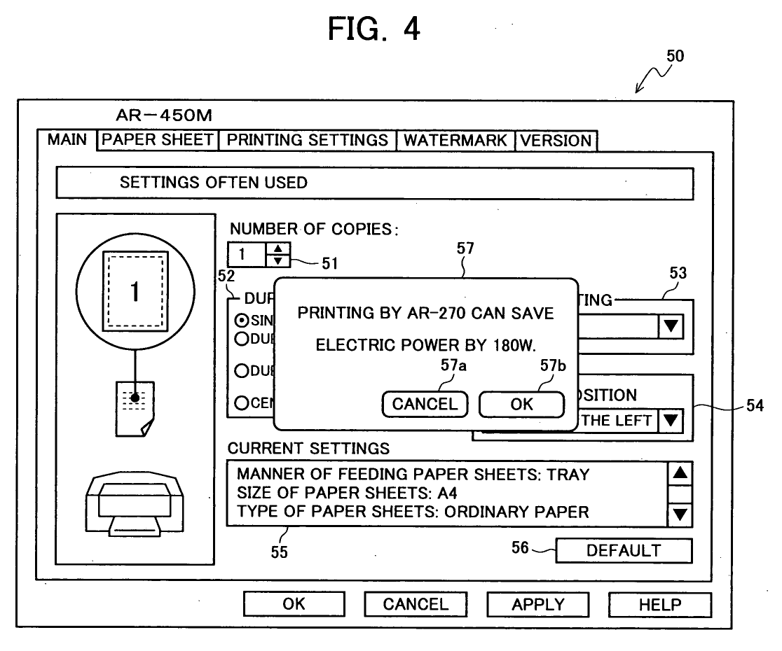

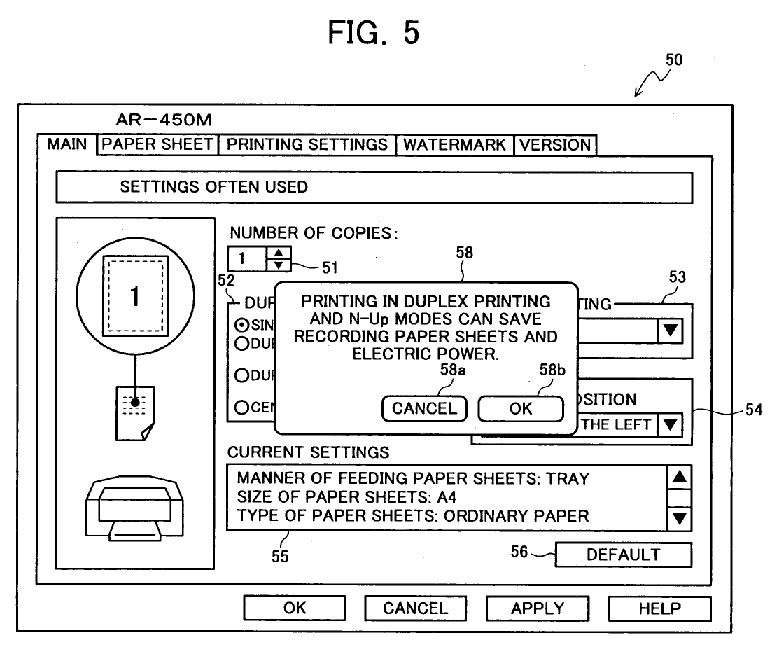

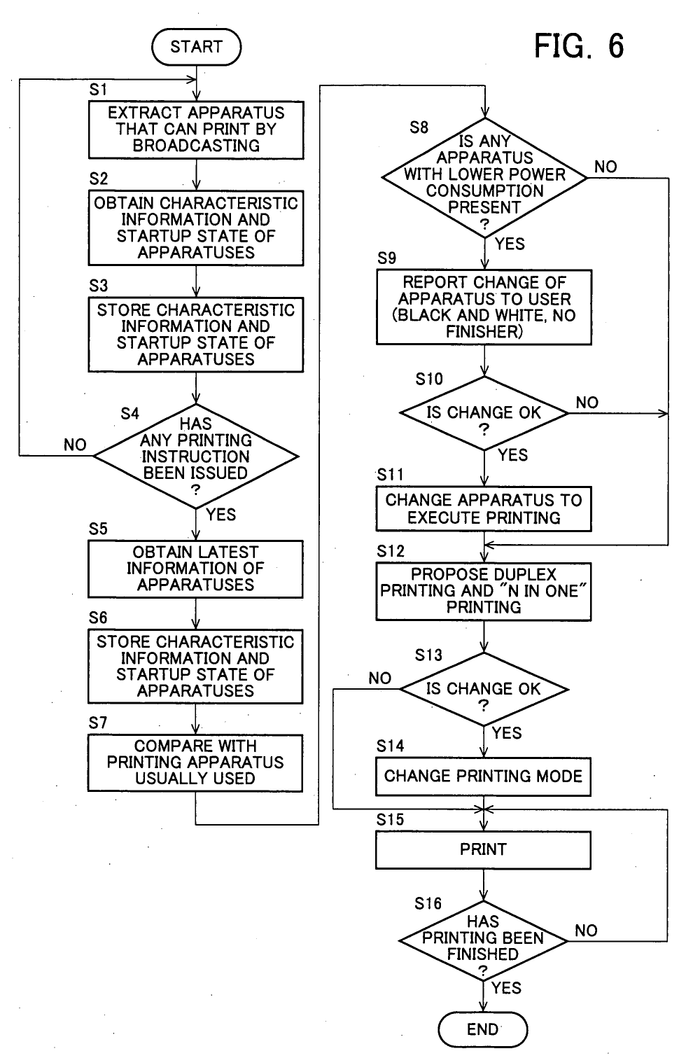

FIG. 3 depicts an example of a printing setting picture in the image forming apparatus of FIG. 1. FIG. 4 depicts an example of a display of a substitute apparatus proposing image in the printing setting picture of FIG. 3. FIG. 5 depicts another example of a display of a substitute apparatus proposing image in the printing setting picture of FIG. 3. FIG. 6 depicts an explanatory flowchart of an example of a substitute apparatus proposing processing in the image forming apparatus of FIG. 1 and is also an explanatory flowchart of an example of an image processing method according to an embodiment of the present invention.

Referring to FIG. 1 and FIGS. 3 to 6, description will be given for the case where the image forming apparatus 1 constitutes the image processing apparatus according to the present invention. The image forming apparatus 1 exemplified in FIG. 1 includes the calculating processing apparatus 11, the image reading portion 12, the image forming portion 13, the image storing portion 14, the apparatus model information managing portion 15, the ROM 16, the memory 17, the displaying portion 18, the operating portion 19, the modem portion 20, the apparatus model information obtaining portion 21, the NW communicating portion 22, and the managing portion 23. A bus connects these components each other.

The calculating processing apparatus 11 is an apparatus that reads a program such as a controlling program stored in the ROM 16 into the memory 17 such as RAM and executes the program, and controls other components in the image forming apparatus 1.

The NW communicating portion 22 is the hardware that controls communication with the PCs 3a and 3b on the network 2 and the external image forming apparatuses 4a to 4d, and enables transmission/reception of various types of data including reception of image data to be printed. The modem portion 20 is constituted of a modem, etc., to execute communication with a facsimile machine connected to the network 2 or connected to another network through a telephone line.

The displaying portion 18 is constituted of a displaying apparatus such as a liquid crystal apparatus, is incorporated therein with a GUI for various types of settings including designation of an object to be printed and printing settings, or the GUI is incorporated in an executable form in the ROM 16, etc. The GUI causes the displaying portion 18 to display the printing setting picture, etc. The operating portion 19 is constituted of operating buttons, etc., and causes a user to input, or select and input the various types of settings including the designation of the object to be printed and the printing settings based on the display on the displaying portion 18. The displaying portion 18 and the operating portion 19 may together be constituted as a touch panel, etc., and may be provided with the operating buttons as well. The printing settings that can be made can be, for example, variable power printing (such as shrinking printing, enlarging printing, variable power printing with designated paper sheets), aggregating printing (n in one), and duplex printing.

The image forming apparatus 1 may be adapted to identify or authenticate a user by causing an individual user or a group user to input the user ID thereof using the operating portion 19 and comparing the user ID with information recorded therein in advance, or authenticating through reading an IC card inserted into the apparatus 1.

The image reading portion 12 detects the presence or the absence of a document using a document detecting sensor for the document set on a document bed, an ADF (Automatic Document Feeder), etc., optically reads the document using a CCD (Charge Coupled Device), and outputs the read data as image data, based on the operations and the printing settings on the operating portion 19. The image storing portion 14 is constituted of a hard disk, etc., and stores the image data read by the image reading portion 12 and image data obtained externally through the NW communicating portion 22. A method of inputting image data from a portion other than the image reading portion 12 can be a method of executing the input of image data in the form of input of an electronic file such as reading a text file from the image storing portion 14 and reading a text file from an external device such as a PC, etc., by transferring a file through the network 2 or receiving electronic mail.

The image forming portion 13 executes printing onto a recording paper sheet for the inputted image data. The image forming portion 13 temporarily stores the image data read by the image reading portion 12 and received data received by the NW communicating portion 22, etc., in a memory and forms an image onto a medium such as a recording paper sheet from a printing portion loaded with a laser scanner unit (LSU). Any portion that can print an image can be employed as the image forming portion 13, and various types of portion such as a portion that once forms an image on a photo-sensitive drum, transfers the image onto a recording paper sheet, and fixes the image; and a portion that directly sprays ink onto a recording paper sheet can be applied to the portion 13.

The image forming portion 13 can also encrypt the data such as the image data stored in the memory thereof and store the encrypted data in the image storing portion 14 and, conversely, the image forming portion 13 can also decrypt the encrypted data stored in the image storing portion 14 and output the decrypted data to an external device through the network 2, etc., through the memory thereof, and print and output the data onto a recording paper sheet.

The apparatus model information obtaining portion 21 obtains apparatus model information of each apparatus from the external image forming apparatuses 4a to 4c on the network 2 through the NW communicating portion 22, and is constituted of an obtaining program stored in the hard disk, etc. The apparatus model information managing portion 15 includes a managing program that manages the apparatus model information of each of the apparatuses 4a to 4c obtained by the apparatus model information obtaining portion 21 by reading the information from the hard disk, etc. The managing portion 23 is a managing program that manages the network address of the image forming apparatus 1 itself and the apparatus model information stored in the hard disk, etc.

Each of the external image forming apparatuses 4a to 4d basically include the components similar to those described for the image forming apparatus 1. However, the external image forming apparatuses 4a to 4d may not include the main featured parts of the present invention including the apparatus model information obtaining portion 21 and the apparatus model information managing portion 15, and a startup state detecting portion, an apparatus selecting portion, and an apparatus presenting portion that are described later.

The image forming apparatus 1 as the main featured part of the present invention includes at least the startup state detecting portion, the apparatus selecting portion, and the apparatus presenting portion that are described later.

The startup state detecting portion is a portion that detects the startup state of each of the external image forming apparatuses 4a to 4d on the network 2, and is incorporated in the ROM 16, etc., so that by the calculation processing apparatus 11 can execute it as a startup state detecting program (a monitoring program). The startup state detecting portion may be partially incorporated into the apparatus model information obtaining portion 21. A “startup state” shows to which of the states such as a standby state where the apparatus can normally execute image forming, a sleeping state where only parts such as the parts corresponding to the modem portion 20 and the NW communicating portion 22 are turned on, a state where the image forming portion 13 is warming up, or an off state where the power is turned off the state of the power source of each of the external image forming apparatuses 4a to 4d corresponds. It is recommendable for the managing portion 23 to register the network addresses, device information, etc., of the external image forming apparatuses 4a to 4d and the PCs 3a and 3b in order to execute detection by the startup state detecting portion.

The apparatus selecting portion is a portion that selects an apparatus that can print with a low power consumption from the external image forming apparatuses 4a to 4d as a candidate apparatus for executing the printing of the inputted image based on the startup state detected by the startup state detecting portion, and is incorporated into the ROM 16, etc., as an apparatus selecting program so that the calculation processing apparatus 11 can execute it. In this case, “based on the startup state” portion that, for example, an apparatus is naturally not to be selected when the startup state thereof is off and, when an apparatus is before or during warming up thereof, the apparatus is not selected as far as possible because it is judged that the apparatus can only print with a high power consumption since the apparatus consumes much power to warm up.

The inputted image to be printed can be (i) the image data read by the image reading portion 12, (ii) the image data read from the image storing portion 14, or (iii) the image data obtained through the NW communicating portion 22.

For example, in the case of (i), the apparatus selecting portion may preferably execute the selection of the candidate apparatus, at the moment when the main body of the image forming apparatus 1 accepts operation to execute a copying processing such as pressing the start button on the operating portion 19 by a user. In the case of (ii), the apparatus selecting portion may execute the selection of the candidate apparatus, at the moment when the main body of the image forming apparatus 1 accepts the operation to execute a printing process or when the main body of the image forming apparatus 1 accepts an order to print a text file stored in the image storing portion 14 from the PC 3a or 3b. In the case of (iii), the apparatus selecting portion may execute the selection of the candidate apparatus, at the moment when the main body of the image forming apparatus 1 receives a facsimile transmission or when the main body of the image forming apparatus 1 receives a printing job with the image data from the PC 3a or 3b.

The apparatus presenting portion is a portion that presents whether the candidate apparatus selected by the apparatus selecting portion is used, to a user being selectable for the user, using an output by a display on the displaying portion 18 or in voice presentation; and includes the displaying portion 18 and/or a speaker. An apparatus presenting program is incorporated into the ROM, etc., so that the calculating processing apparatus 11 can execute it to control the apparatus presenting portion. The apparatus presenting program can be said to be a substitute apparatus presenting program or a substitute apparatus proposing program because the program proposes the selection of a substitute apparatus to the user by presenting a substitute apparatus.

Not only the external image forming apparatuses 4a to 4d but also the main body of the image forming apparatus 1 may be added to the subjects of the processing in the featured parts of the present invention such as the startup state detecting portion, the apparatus selecting portion, and the apparatus presenting portion. For example, the apparatus selecting portion may select a candidate apparatus from the apparatus 1 itself and the external image forming apparatuses 4a to 4e as the candidate apparatus.

An image processing method accompanied by a substitute apparatus proposing processing according to the present invention, executed by the image forming apparatus 1 configured as above will be exemplified based on the flow of FIG. 6 referring to the system configuration of FIG. 1 and the displaying pictures of FIGS. 3 to 5.

The startup state detecting portion of the image forming apparatus 1 detects the startup state of each of the external image forming apparatuses 4a to 4d at predetermined intervals. As depicted in, for example, FIG. 2, the startup state detecting portion first extracts an apparatus that can print by broadcasting from the external image forming apparatuses 4a to 4d (step S1).

At step S1, (I) each of all the external image forming apparatuses on the network 2 is inquired of about the model name and the network address (in this case, the IP address) thereof and, preferably, the installed location thereof by broadcasting. To this inquiry, (II) the external image forming apparatuses that are turned on and that are at least the products of the same manufacturer as that of the image forming apparatus 1 (namely, the products of the company of the image forming apparatus 1) (for example, the image forming apparatuses 4a, 4b, and 4d) can respond. Due to these responses, the state where the power is turned on or off of the startup states can be detected. Actually, the apparatus 4c is not the product of the company and often can not respond even when the apparatus 4c is turned on. However, the apparatus 4c does not have to be subject to the apparatus selection and the apparatus presentation of the present invention. The selection and the presentation can often be executed only with the products of the company to be selected and presented. When no apparatus can be selected, the printing may only be executed by an external image forming apparatus that the user has originally designated (including default designation).

(III) The startup state detecting portion issues a transmission request of the characteristic information and the startup state of each of the apparatuses (for example, the apparatuses 4b and 4d) by multi-scanning to the external image forming apparatuses 4b and 4d that have responded. In response to this transmission request, (IV) each of the apparatuses 4b and 4d transmits the characteristic information and the startup state thereof to the image forming apparatus 1. Due to the above (III) and (IV), the startup state detecting portion obtains the characteristic information and the startup state of each of the apparatuses 4b and 4d (step S3). The characteristic information transmitted in this case is the information that indicates, for example, the model name (apparatus model name), the printing performance including the state of attachment of optional devices, and the power consumption. The information indicating the startup state is the information indicating which state the apparatus is currently in such as the standby state (a state where the apparatus can be used normally), the sleeping state, and being warmed up, etc. The startup state detecting portion that has obtained the characteristic information and the startup state stores that information using the apparatus model information managing portion 15, etc., and manages that information by correlating each other in a table (step S4). The information indicating the power consumption may include the value of the power consumption corresponding to each of the above startup states.

The above image forming apparatus 1 preferably includes a characteristic obtaining portion that obtains the characteristic information. The characteristic obtaining portion is incorporated into the ROM 16, etc., as a characteristic obtaining program (a kind of monitoring program) in an executable form so that the calculation processing apparatus 11 can execute it to obtain characteristic information including the power consumption and the printing performance of each of the external image forming apparatus regularly and/or when the image to be printed is inputted, from the external image forming apparatuses, and to store (or may temporarily store) the obtained information in the apparatus model information managing portion 15. An apparatus selecting program may refer to the characteristic information of the apparatuses stored according to the characteristic obtaining program and, thereby, may select an apparatus that can print with a low power consumption. Actually, the state of attachment of optional devices may vary from that of the time of the purchase and, therefore, is preferably obtained as one of the characteristic information. However, other characteristic information do not need to be obtained every time because that information is always the same for the external image forming apparatus when that information is once stored.

In the above state, after the user has executed user authentication using the operating portion 19 of the image forming apparatus 1, etc., the user designates a file to be printed or places a document. Watching the printing setting picture 50 exemplified in FIG. 3 displayed on the displaying portion 32, the user makes settings for printing on the operating portion 37 and instructs printing by pressing down an OK button, etc. (YES at step S4). For the printing settings, as exemplified in FIG. 3, it is assumed that an external image forming apparatus referred to as “AR-450M” (assuming that this apparatus corresponds to the apparatus 4b) is designated by the user as the apparatus to execute the printing. In the above case, when the user designates the apparatus 4c that is a product of another manufacturer, processing subsequent to this will be basically the same.

The printing setting picture 50 exemplified in FIG. 3 displays a sheet quantity input column 51 to be inputted with the number of paper sheets to be printed; a duplex/simplex designation column 52 to select any one of single side printing, duplex printing (transversal binding), duplex printing (longitudinal binding), and central binding printing; an aggregating printing mode designation column 53 to select any one of a plurality of “N-Up” printing modes (aggregating printing modes) such as One-Up (ordinary printing), Two-Up (two in one), Four-Up (four in one), and Eight-Up (eight in one); a position designation column 54 to designate a binding position from “right”, “left”, “top”, and “bottom”; and a default setting designating button 56 to designate the setting of the apparatus to be the default setting, that can be operated by a user using the operating portion 19. The printing setting picture 50 also displays each condition having been set by the above printing settings in a printing setting displaying column 55 and the user can confirm those settings.

Having received this printing instruction, the startup state detecting portion again obtains the latest characteristic information and the startup state similarly at step S2 (step S5) and causes the apparatus model information managing portion 15 to store the obtained information (step S6). At step S5, the startup state detecting portion may only obtain the information by multi-scanning. In this case, even at the present point, similarly to the case of step S2, it is assumed that the startup state detecting portion can obtain and store the characteristic information and the startup state of each of the external image forming apparatuses 4b and 4d by multi-scanning the apparatuses 4b and 4d.

In the image forming apparatus 1, the apparatus selecting portion first extracts the apparatuses 4b and 4d from the external image forming apparatuses 4a to 4d based on the startup states detected by the startup state detecting portion and, from these two apparatuses, selects an apparatus that can print with a low power consumption as the candidate apparatus for executing the printing of the inputted image. In this case, the apparatus selecting portion obtains the power consumption of each of the two apparatuses 4b and 4d from the apparatus model information managing portion 15, and compares the power consumption for printing in the apparatus 4b designated by the user with that obtained above for each apparatus to decide which apparatus can print with a lower power consumption (step S7). In this case, the comparison is executed between the apparatus 4b designated by the user and the apparatus 4d of the two apparatuses that is not the same as the apparatus 4b designated by the user. Following step S7, the apparatus selecting portion judges whether any apparatus with a lower power consumption is present (step S8).

In this example, the startup state detecting portion has extracted the two apparatuses 4b and 4d assuming that both of the apparatuses 4b and 4d have completed the warming up thereof. However, when an apparatus has not completed the warming up thereof is present according to the startup state thereof that the startup state detecting portion detects, warming up itself increases the power consumption and, therefore, such an apparatus is preferably not extracted.

When it is found that the apparatus 4d consumes lower power than the apparatus 4b does as a result of the judgment at step S8 (YES at step S8), the apparatus selecting portion delivers the result to the apparatus presenting portion. The apparatus presenting portion presents whether the user desires to use the candidate apparatus 4d that the apparatus selecting portion has selected, to the user being executable by the user (step S9).

At step S9, for example, as in a substitute apparatus proposing image (substitute apparatus presenting image) 57 of FIG. 4, the candidate apparatus 4d (corresponds to the name of the apparatus model “AR-270”) is displayed and is reported, and the saved amount that can be calculated at step S7 (in this case, 180W) and a text “You can save power.” are also displayed. In the substitute apparatus proposing image 57, a canceling button 57a and an OK button 57b are displayed to be selectable by a user. The user may select the OK button 57b when the user admits this change of the apparatus model, and the user may select the canceling button 57a when the user does not admit this change of the apparatus model.

As described above, the above apparatus presenting portion preferably presents the user with an announcement that the power can be saved in printing using the candidate apparatus that the apparatus selecting portion has selected, and whether the user desires to use the candidate apparatus, to the user being selectable by the user.

In this case, it is assumed that the candidate apparatus 4d “AR-270” can execute printing only in black and white and does not include any finisher and, therefore, the apparatus selecting portion judges that this apparatus 4d can print with a lower power consumption than the apparatus 4b “AR-450M” that the user has designated. In practice, the judgment is executed based on the value in the apparatus model information managing portion 15.

To select an apparatus with a lower power consumption by even changing the printing mode as above, the image forming apparatus 1 needs to include a job analyzing portion. The job analyzing portion is a portion that analyze a printing job for an inputted image, and is incorporated into the ROM 16, etc., as a job analyzing program so that the calculating processing apparatus 11 can execute it.

When an printing job is a color printing job as the result of an analysis by the job analyzing portion of the printing job, the apparatus selecting portion preferably selects an apparatus that can execute the printing job as a printing job for printing in black and white (even accepting the change to printing in black and white) and that can print with a low power consumption based on the startup state detected by the startup state detecting portion, as a candidate apparatus from the external image forming apparatuses. In this manner, even when a printing job is originally a color printing job, an apparatus that can print with a low power consumption can be proposed by allowing the printing in black and white.

Similarly, when a printing job is a printing job that uses a finisher as the result of an analysis by the job analyzing portion of the printing job, the apparatus selecting portion preferably selects an apparatus that can execute the printing job as a printing job that does not use any finisher and that can print with a low power consumption based on the startup state detected by the startup state detecting portion, as a candidate apparatus from the external image forming apparatuses. In this manner, even when a printing job is originally a printing job that uses a finisher, an apparatus that can print with a low power consumption can be proposed by excluding the finisher.

As described above, rewriting of the printing jobs is necessary when the printing jobs are finally executed as printing jobs for printing in black and white and/or using the finisher. The rewriting of the printing jobs is also necessary when the user finally permits the change of the apparatus from the apparatus designated by the user to the candidate apparatus.

Following step S9, the calculation processing apparatus 11 of the image forming apparatus 1 judges whether the user permits the change of the apparatus from the apparatus 4b “AR-450M” designated by the user to the candidate apparatus 4d “AR-270” based on the selection by the user from the operating portion 19 (step S10). When the change is permitted at step S10, the calculating processing apparatus 11 makes a change to print using the apparatus 4d “AR-270” (step S11).

When the result is “NO” at step S10 and when the processing at step S11 has been finished, the apparatus presenting portion presents the user with the proposal, so that the user can select whether the printing is executed in duplex printing and “n in one” (step S12). Because it is proposed at step S12 that duplex printing and “n in one” printing can be executed with a lower power consumption and can save more paper sheets (can save more power consumed when the paper is produced) than single side printing and “one-Up” printing, the proposal at step S12 may be judged simultaneously at step S8 or the processing itself at step S12 may be executed simultaneously with that of step S9.

The proposal at step S12 may be executed, for example, by the presentation of a substitute apparatus proposing image 58 as depicted in FIG. 5. The substitute apparatus proposing image 58 displays thereon a canceling button 58a and an OK button 58b that are selectable by the user. The user may select the OK button 58b when the user accepts this setting change, and may select the canceling button 58a when the user does not accept the setting change.

To enable the proposal at step S12, when the printing job is a printing job to execute single side printing as the result of the analysis of the printing job by the job analyzing portion, the apparatus selecting portion preferably selects an apparatus that can execute the printing job as a printing job to execute duplex printing and that can print with a low power consumption based on the startup state detected by the startup state detecting portion, as a candidate apparatus from the external image forming apparatuses. In this manner, even when a printing job is originally a job for single side printing, an apparatus that can print with a low power consumption can be proposed by accepting duplex printing for the job.

Similarly, the apparatus selecting portion preferably selects an apparatus that can execute the printing job analyzed by the job analyzing portion as a printing job for aggregating printing and that can print with a low power consumption based on the startup state detected by the startup state detecting portion, as a candidate apparatus from the external image forming apparatuses. In this manner, an apparatus that can print with a low power consumption can be proposed by accepting “N-Up” printing even when the printing job is originally a job for “one-Up” printing or by accepting “four or more-Up” printing even when the printing job is originally a job for “two-Up” printing.

As described for black-and-white printing, printing that does not use any finisher, duplex printing, and aggregating printing, the apparatus selecting portion preferably selects an apparatus that can print with a lower power consumption even by changing the printing mode of the printing job. That is, the apparatus selecting portion preferably selects an apparatus that can execute a printing job analyzed by the job analyzing portion even by permitting the change of the printing mode and that can print with a low power consumption based on the startup state detected by the startup state detecting portion, as a candidate apparatus from the external image forming apparatuses. The change of the printing mode may include stopping stabling.

On the contrary, the apparatus selecting portion may not accept to change the printing mode of the printing job and may select an apparatus that can print in the original printing mode. The user may set whether the changing the printing mode is permitted.

In any case, the description has been given on condition that the change of the external image forming apparatus (that may include the case that the change of the printing mode accompanied) is executed in the stage where the printing job is inputted. However, when the change is made to the candidate of substitute apparatus in the stage where a printing job is created, that is, the stage where the user has designated an external image forming apparatus and has made the printing setting, no analysis and no rewriting of the printing job are necessary. Even in this case, each application that is subject to the printing job can be applied. That is, a form of selecting an apparatus with a low power consumption as a candidate apparatus even accepting the change of the printing mode or a form of selecting an apparatus with a low power consumption as a candidate apparatus within the scope where no change of the printing mode is accepted can also be applied even in the stage where no printing job has been created.

Following step S12, the calculation processing apparatus 11 of the image forming apparatus 1 judges whether the change to duplex printing and “n in one” printing is permitted based on the selection of the user from the operating portion 19 (step S13). When the change is permitted at step S13, the calculation processing apparatus 11 changes the printing mode for printing (step S14). When the result is NO at step S13, the printing mode remains in the state first designated by the user.

After the processing at step S14 and when the judgment result is NO at step S13, the calculation processing apparatus 11 creates or updates the printing job to print in a printing mode designated by the user or determined at step S14 for the external image forming apparatus designated by the user or determined at step S11, and causes the external image forming apparatus to print by instructing the apparatus to print (step S15). The calculation processing apparatus 11 judges whether the printing instructed at step S15 has been completed (step S16). The apparatus 11 continues the printing when the printing has not been completed, and ends the processing when the printing has been completed.

In the embodiment, as described above, the image forming apparatus 1 operated by the user proposes and reports to the user the change from the printer or the copying machine that can print according to the instruction of the user to the printer or the copying machine that can print with a low power consumption, and thereby, it can realizes a low power consumption, and can cause the user to promote the ecology. That is, according to the embodiment, not only that the printing can be executed by an apparatus with a low power consumption of a plurality of image forming apparatuses connected through a network but also that the user can be caused to recognize the apparatus that actually executes the printing. Thereby, the user can be caused to promote the ecology.

Referring to FIGS. 2 to 6, description is given for the case where a computer constitutes the image forming apparatus according to the present invention. When a computer constitutes the image forming apparatus according to the present invention, a program may be installed in various ROMs or a hard disk as so-called a printer driver or a printer monitoring program with a GUI for display so that it can be executed by a CPU. In this configuration, the same application as that configured with the image forming apparatus according to the present invention as the image forming apparatus 1 can also be employed and the description for the details thereof is omitted. However, which application can be applied is obviously understood by recognizing the difference of the description for the flow of FIG. 6.

The PC 3 exemplified in FIG. 2 includes the CPU 31, the displaying portion 32, the memory 33, the ROM 34, the printing managing portion 35, the mail managing portion 36, the operating portion 37, the modem portion 38, the communicating portion 39, the managing portion 40, and the storing portion 41, and these components are connected by a bus.

The operating portion 37 is constituted of a keyboard or a mouse to input various types of information including various settings including designation of object to be printed and printing settings for a user. The storing portion 41 is a storing apparatus such as a hard disk or an external recording medium reading apparatus. The communicating portion 39 is hardware that controls the communication with the external image forming apparatuses 4a to 4d and the PCs 3a and 3b, and this enables transmission and reception of various data including transmission of image data to be printed and printing instructions. The modem portion 38 is constituted of a modem, etc., to execute communication with a facsimile machine connected to the network 2 or connected to another network through a telephone line.

The displaying portion 32 is a display such as a CRT or a LCD to display various data including various settings including designation of object to be printed and printing settings. The printing managing portion 35 includes a program to control printing (such as a printer driver or a printer monitoring program) that controls the printing by the external image forming apparatuses 4a to 4d connected to the PC 3, and the storing portion 41, etc., actually stores this program in an executable form.

The mail managing portion 36 is constituted of a mailer that executes transmission and reception of mail through the communicating portion 39 and the modem portion 38, etc., and the ROM 34, the storing portion 41, etc., actually store this program in an executable form. The managing portion 40 is constituted of a managing program that manages electronic files and the information thereof, and the ROM 34, the storing portion 41, etc., actually store this program in an executable form. The ROM (which may be a rewritable ROM) 34 is a memory that stores an OS (Operating System) and other controlling programs in executable forms. The CPU 31 is a calculation processing apparatus to execute the programs stored in the ROM 34 and the storing portion 41, and the memory 33 such as a RAM is the execution area for the CPU 31.

To execute the used amount display of paper according to the present invention using the PC 3, the mail managing portion 36, the modem portion 38, and the managing portion 40 are not indispensable. However, the mail managing portion 36 and the modem portion 38 may also be used to receive image files to be printed and the managing portion 40 may also be used to read the image files stored in the hard disk, etc.

The PC 3 first detects the startup state of each of the external image forming apparatuses 4a to 4d at predetermined intervals, and stores the detected result in the storing portion 41, etc., (step S1 to S3). In this case, the PC 3 may also preferably include a characteristic obtaining portion.

In this state, after a user has executed user authentication, etc., using the operating portion 37 of the PC 3, the user designates a file to be printed. Watching the printing setting picture 50 exemplified in FIG. 3 displayed on the displaying portion 32, the user makes settings for printing on the operating portion 37 and instructs printing by pressing down an OK button, etc. (YES at step S4). For the printing settings, as exemplified in FIG. 3, the external image forming apparatus referred to as “AR-450M” (assuming that this apparatus corresponds to the apparatus 4b) is designated by the user as the apparatus to execute the printing.

Having received this printing instruction, the startup state detecting portion again obtains the latest characteristic information and the startup state similarly at step S2 (step S5) and causes the apparatus model information managing portion 15 to store the obtained information (step S6). In this case, even at the present point, similarly in the case of step S2, it is assumed that the startup state detecting portion can obtain and store the characteristic information and the startup state of each of the external image forming apparatuses 4b and 4d by multi-scanning the apparatuses 4b and 4d.

In the PC 3, the apparatus selecting portion first extracts the apparatuses 4b and 4d from the external image forming apparatuses 4a to 4d based on the startup states detected by the startup state detecting portion and, from these two apparatuses, selects an apparatus that can print with a low power consumption as the candidate apparatus for executing the printing of the inputted image. In this case, the apparatus selecting portion obtains the power consumption of each of the two apparatuses 4b and 4d from the apparatus model information managing portion 15, and compares the power consumption for printing in the apparatus 4b designated by the user with that in the apparatus 4d to decide which apparatus can print with a lower power consumption (step S7). Following step S7, the apparatus selecting portion judges whether any apparatus with a lower power consumption is present (step S8).

As the result of the judgment at step S8, the apparatus 4d consumes power lower than the apparatus 4b (step S8: YES), the apparatus selecting portion delivers the result to the apparatus presenting portion. The apparatus presenting portion presents a user with the information of the candidate apparatus 4d that the apparatus selecting portion has selected as a candidate, so that the user can decide whether to use it or not (step S9), for example, like a substitute apparatus proposing image 57.

Following step S9, the CPU 31 of the PC 3 judges whether the user permits the change of the apparatus from the apparatus 4b “AR-450M” designated by the user to the candidate apparatus 4d “AR-270” based on the selection by the user from the operating portion 37 (step S10). When the change is permitted at step S10, the CPU 31 makes a change to print using the apparatus 4d “AR-270” (step S1).

When the result is “NO” at step S10 and when the processing at step S11 has been finished, the apparatus presenting portion presents the user with the proposal, like the substitute apparatus proposing image 58, so that the user can select whether the printing is executed in duplex printing and “n in one” (step S12). Following step S12, the CPU 31 of the PC 3 judges whether the change to duplex printing and “n in one” printing is permitted based on the selection of the user from the operating portion 37 (step S13). When the change is permitted at step S13, the CPU 31 changes the printing mode for printing (step S14). When the result is NO at step S13, the printing mode remains in the state first designated by the user.

After the processing at step S14 and when the judgment result is NO at step S13, the CPU 31 creates or updates the printing job to print in a printing mode designated by the user or determined at step S14 for the external image forming apparatus designated by the user or determined at step S11, and causes the external image forming apparatus to print by instructing the apparatus to print (step S15). The CPU 31 judges whether the printing instructed at step S15 has been completed (step S16). The CPU 31 continues the printing when the printing has not been completed, and ends the processing when the printing has been completed.

As described above, the PC 3 may also include the job analyzing portion as a job analyzing program installed in the ROM 34, the storing portion 41, etc., so that the CPU 31 can execute the program. The apparatus selecting portion preferably selects an apparatus that can print with a lower power consumption even by changing the printing mode of the printing job into black-and-white printing, printing that does not use any finisher, duplex printing, or aggregating printing. On the contrary, the apparatus selecting portion may not permit to change the printing mode of the printing job and may select an apparatus that can print in the original printing mode. The user may set whether the changing the printing mode is permitted. A form of selecting an apparatus with a low power consumption as a candidate apparatus even by accepting the change of the printing mode or a form of selecting an apparatus with a low power consumption as a candidate apparatus within the scope where no change of the printing mode is accepted can also be employed even in the stage where no printing job has been generated.

In the embodiment, as described above, the PC 3 of the user proposes and reports to the user the change from the printer or the copying machine that can print according to the instruction of the user to the printer or the copying machine that can print with a low power consumption, thereby, can realizes a low power consumption, and can cause the user to promote the ecology. That is, according to the embodiment, not only that the printing can be executed by an apparatus with a low power consumption of a plurality of image forming apparatuses connected through a network but also that the user can be caused to recognize the apparatus that actually executes the printing. Thereby, the user can be caused to promote the ecology.

As described above, referring to FIGS. 1 to 6, description has been given for each of the embodiments including mainly the image processing apparatus, the image processing method, and the program of the present invention. However, the above program can be distributed as a computer-readable recording medium recording the program and can be delivered through a network.

A simplified description will be given for a recording medium recording the programs and the data to realize the function of proposing a substitute apparatus according to the present invention. CD-ROM, photo-magnetic disk, DVD-ROM, FD, flash memory, and various types of other ROMs and RAMs can be considered as specific example of recording medium. The above described programs are recorded in these recording media and distributed and, thereby, the realization of the function is facilitated. The above described recording medium is attached to the computer exemplified in FIG. 2, thereby, the programs are read, and the programs are transferred to and stored in the ROM 16, etc., in the image forming apparatus 1 shown in FIG. 1, and the programs are read when necessary. Thereby, the function of proposing the substitute apparatus according to the present invention can be executed by the displaying portion 18 or a audio output portion of the image forming apparatus 1. When the programs are executed on the computer (PC 3) exemplified in FIG. 2, the above described recording medium is attached to the PC 3 or the programs are stored in the ROM 34, etc., of the PC 3, and the programs are read when necessary. And thereby, the function of proposing the substitute apparatus according to the invention can be executed.

According to the invention, not only that the printing can be executed by an apparatus with a low power consumption of a plurality of image forming apparatuses connected through a network but also that the user can be caused to recognize the apparatus that actually executes the printing. In addition, the user can be caused to promote the ecology.

1. An image processing apparatus connected to a plurality of external image forming apparatuses through a network, which comprises:
a startup state detecting portion that detects a startup state of each of the external image forming apparatuses;
an apparatus selecting portion that selects, as a candidate apparatus to execute printing of an inputted image, an apparatus that is able to print with a low power consumption based on the startup state detected by the startup state detecting portion, from the external image forming apparatuses; and
an apparatus presenting portion that presents to a user whether the candidate apparatus selected by the apparatus selecting portion is used, being selectable by the user.

2. An image processing apparatus as defined in claim 1, wherein
the apparatus presenting portion presents to the user presentation informing that electric power is saved by printing using the candidate apparatus selected by the apparatus selecting portion, and whether the candidate apparatus is used, being selectable by the user.

3. An image processing apparatus as defined in claim 1, wherein
the apparatus selecting portion selects an apparatus for which the startup state detected by the startup detecting portion indicates warming up thereof has completed and that is able to print with a low power consumption from the external image forming apparatuses as the candidate apparatus.

4. An image processing apparatus as defined in claim 1, further comprising
a job analyzing portion that analyzes a printing job for the inputted image, wherein
the apparatus selecting portion selects an apparatus that is able to execute the printing job analyzed by the job analyzing portion and that is able to print with a low power consumption based on the startup state detected by the startup state detecting portion from the external image forming apparatuses as the candidate apparatus.

5. An image processing apparatus as defined in claim 1, further comprising
a characteristic obtaining portion that obtains and stores characteristic information including a power consumption and the printing performance of each apparatus of the external image forming apparatus, wherein
the apparatus selecting portion selects an apparatus that is able to print with a low power consumption referring to the characteristic information of each apparatus stored in the characteristic obtaining portion.

6. An image processing apparatus as defined in claim 5, further comprising
a job analyzing portion that analyzes a printing job for the inputted image, wherein
the apparatus selecting portion selects an apparatus that is able to execute the printing job analyzed by the job analyzing portion even permitting a change of the printing mode thereof and that is able to print with a low power consumption based on the startup state detected by the startup state detecting portion from the external image forming apparatuses as the candidate apparatus.

7. An image processing apparatus as defined in claim 6, wherein
when the printing job is a color printing job as the result of the analysis of the printing job by the job analyzing portion, the apparatus selecting portion selects an apparatus that is able to execute the printing job as a printing job for printing in black and white and that is able to print with a low power consumption based on the startup state detected by the startup state detecting portion from the external image forming apparatuses as the candidate apparatus.

8. An image processing apparatus as defined in claim 6, wherein
when the printing job is a printing job that uses a finisher as the result of the analysis of the printing job by the job analyzing portion, the apparatus selecting portion selects an apparatus that is able to execute the printing job as a printing job that does not use any finisher and that is able to print with a low power consumption based on the startup state detected by the startup state detecting portion from the external image forming apparatuses as the candidate apparatus.

9. An image processing apparatus as defined in claim 6, wherein
when the printing job is a printing job to execute single side printing as the result of the analysis of the printing job by the job analyzing portion, the apparatus selecting portion selects an apparatus that is able to execute the printing job as a printing job to execute duplex printing and that is able to print with a low power consumption based on the startup state detected by the startup state detecting portion from the external image forming apparatuses as the candidate apparatus.

10. An image processing apparatus as defined in claim 6, wherein
the apparatus selecting portion selects an apparatus that is able to execute the printing job analyzed by the job analyzing portion as a printing job to execute aggregating printing and that is able to print with a low power consumption based on the startup state detected by the startup state detecting portion from the external image forming apparatuses as the candidate apparatus.

11. An image processing apparatus as defined in claim 1, wherein
the image processing apparatus is a computer.

12. An image processing apparatus as defined in claim 1, wherein
the image processing apparatus is an image forming apparatus, and wherein
the processing aimed at the external image forming apparatuses is aimed at not only the external image forming apparatuses but also the image processing apparatus itself.

13. An image processing method of executing a printing instruction in an image processing apparatus connected to a plurality of external image forming apparatuses through a network, which includes:
a startup state detecting step at which a startup state detecting portion detects the startup state of each of the external image forming apparatuses;
an apparatus selecting step at which an apparatus selecting portion selects an apparatus that is able to print with a low power consumption based on the startup state detected at the startup state detecting step from the external image forming apparatuses as a candidate apparatus to be caused to execute printing of an inputted image; and
an apparatus presenting step at which an apparatus presenting portion presents whether the candidate apparatus selected at the apparatus selecting step is used to a user being executable by the user.

14. A program to be installed in a controlling portion of an image processing apparatus connected to a plurality of external image forming apparatuses through a network and to execute a printing instruction, wherein
the program causes the controlling portion to execute
a startup state detecting step of detecting the startup state of each of the external image forming apparatuses,
an apparatus selecting step of selecting an apparatus that can print with a low power consumption based on the startup state detected at the startup state detecting step from the external image forming apparatuses as a candidate apparatus to be caused to execute printing of an inputted image; and
an apparatus presenting step of presenting whether the candidate apparatus selected at the apparatus selecting step is used to a user being executable by the user.
